(19) United States
(12) Patent Application Publication
(10) Pub. No.: US 2007/0030300 A1
(43) Pub. Date: Feb. 8, 2007

(54) Inkjet image forming apparatus, and method of detecting malfunctioning nozzle thereof

(75) Inventor: Jin-wook Jeong, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/476,751

(22) Filed: Jun. 29, 2006

(30) Foreign Application Priority Data
Aug. 5, 2005 (KR) 2005-71693

(51) Int. Cl. B41J 29/393

(52) U.S. Cl. 347/19

(57) ABSTRACT

An inkjet image forming apparatus and a method of detecting a malfunctioning nozzle thereof. The inkjet image forming apparatus includes a printhead having a nozzle unit and having a length corresponding to a width of a print medium, an ejection driving unit to drive the printhead to print an image on the print medium, a control unit to generate control signals to print first test print patterns to detect a group of nozzles having a malfunctioning nozzle after dividing nozzles of the nozzle unit into a predetermined number of groups of nozzles, and second test print patterns to detect a position of the malfunctioning nozzle in the group of nozzles having the malfunctioning nozzle, and a detecting unit to detect the position of the malfunctioning nozzle in the nozzle unit using the first and second test print patterns.

### CROSS-REFERENCE TO RELATED APPLICATIONS

This application claims priority under 35 U.S.C. §119(a) from Korean Patent Application No. 10-2005-0071693, filed on Aug. 05, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus and a method of easily and accurately detecting a malfunctioning nozzle thereof.

2. Description of the Related Art

In general, an inkjet image forming apparatus forms images by ejecting ink from a printhead, which moves back and forth in a direction perpendicular to a transferring direction of a print medium. Such an inkjet image forming apparatus is referred to as a shuttle type inkjet image forming apparatus. A nozzle unit having a plurality of nozzles for ejecting ink is installed in a printhead of the shuttle-type inkjet image forming apparatus.

Recently, to satisfy users' demand for high-speed printing, a printhead having a nozzle unit with a length corresponding to a width of print medium has been suggested. Such an inkjet image forming apparatus is referred to as a line printing type inkjet image forming apparatus.

In the line printing type inkjet image forming apparatus, a printhead is fixed and only a print medium is transferred. Accordingly, each nozzle disposed in the printhead ejects ink onto a fixed area on the print medium. If a nozzle in the printhead malfunctions, a missing line such as a white band appears on the print medium. Therefore, it is important to accurately detect the position of the malfunctioning nozzle and compensate for it.

Since the shuttle type inkjet image forming apparatus has a few nozzle units, malfunctioning nozzles can be detected by printing a test page. However, the line printing type inkjet image forming apparatus has many nozzles, and thus it is not easy to accurately detect the position of a malfunctioning nozzle. In addition, a highly accurate scanner is required to accurately detect the position of a malfunctioning nozzle, thereby increasing the manufacturing cost of the inkjet image forming apparatus. Also, even if the highly accurate scanner is used, the accurate detection of the position of a malfunctioning nozzle is still difficult, because of physical errors, such as a skew between a long nozzle array and a small distance between nozzles. Hence, there is a need to accurately detect the position of a malfunctioning nozzle.

### SUMMARY OF THE INVENTION

The present general inventive concept provides an inkjet image forming apparatus and a method of detecting a malfunctioning nozzle thereof which can accurately detect a malfunctioning nozzle using a cheap detecting unit.

The present general inventive concept also provides an inkjet image forming apparatus and a method of detecting a malfunctioning nozzle thereof which can recover a malfunctioning nozzle when the malfunctioning nozzle exists.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus, including a printhead having a nozzle unit and having a length corresponding to a width of a print medium or longer, an ejection driving unit to drive the printhead to print an image on the print medium, a control unit to generate control signals to print first test print patterns to detect a group of nozzles having a malfunctioning nozzle after dividing nozzles of the nozzle unit into a predetermined number of groups of nozzles, and second test print patterns to detect a position of the malfunctioning nozzle in the group of nozzles having the malfunctioning nozzle, and a detecting unit to detect the position of the malfunctioning nozzle in the nozzle unit using the first and second test print patterns.

The control unit may control the printhead to print reference indicators to indicate locations of the groups of nozzles in the first test print patterns such that the detecting unit can detect the locations of the groups of nozzles.

The reference indicators may be lines having a predetermined length in a transferring direction of the print medium, and are spaced apart from each other in the width direction of the print medium.

The control unit may control the ejection driving unit to sequentially drive the nozzles of the group of nozzles having the malfunctioning nozzle at predetermined time intervals and starting from a first nozzle in order to print the second test print patterns such that the detecting unit can detect the position of the malfunctioning nozzle in the group of nozzles having the malfunctioning nozzle.

The detecting unit may include a light emitting unit to radiate light onto the print medium, and a light receiving unit to receive light reflected from the print medium.

The detecting unit may include a reading unit to radiate light onto the print medium on which ink is ejected when passing through the nozzle unit, to detect light reflected from the print medium, and to read information about a malfunctioning nozzle from the print medium.

The reading unit may include a case, a light source emitting light to emit light onto the print medium, a reflection unit which is installed apart from the light source at a predetermined distance and to reflect the light emitted from the light source toward the print medium, a mirror unit to reflect the light reflected from the print medium in a predetermined direction, a lens unit disposed along a light path of the light reflected from the mirror unit, and a reading member to detect the light passing through the lens unit and to read the about the malfunctioning nozzle from the print medium, in which the light source, the reflection unit, the mirror unit, the lens unit, and the reading member are installed in the case.

The mirror unit may include a single mirror.

The detecting unit may radiate complementary color lights onto the first and second test print patterns to increase an efficiency of the detection of the malfunctioning nozzle.

The foregoing and/or other aspects and utilities of the present general inventive concept may also be achieved by providing a method of detecting a malfunctioning nozzle in an inkjet image forming apparatus which includes a printhead having nozzle unit and having a length corresponding to a width of a print medium or longer, the method including printing first test print patterns to detect a group of nozzles having a malfunctioning nozzle, detecting the group of nozzles having the malfunctioning nozzle using the first test print patterns, printing second test print patterns to detect a position of the malfunctioning nozzle in the group of nozzles having the malfunctioning nozzle, and detecting the position of the malfunctioning nozzle using the second test print patterns.

The printing of the first test print patterns may include printing reference indicators to indicate locations of a plurality of groups of nozzles, including the group of nozzles having the malfunctioning nozzle, in the first test print patterns such that the detecting unit can detect the locations of the plurality of groups of nozzles.

The reference indicators may be lines having a predetermined length in a transferring direction of the print medium, and are spaced apart from each other in a width direction of the print medium.

The printing of the second test print patterns may include sequentially driving the nozzles of the group of nozzles having the malfunctioning nozzle at predetermined time intervals and starting from a first nozzle in order to print the second test print patterns such that the detecting unit can detect the position of the malfunctioning nozzle in the group of nozzles having the malfunctioning nozzle.

The detecting unit may include a light emitting unit to radiate light onto the print medium, and a light receiving unit to receive light reflected from the print medium.

The detecting unit may include a reading unit to radiate light onto the print medium on which ink is ejected when passing through the nozzle unit, to detect light reflected from the print medium, and to read information about a malfunctioning nozzle from the print medium.

The reading unit may include a case, a light source emitting light to emit light onto the print medium, a reflection unit which is installed apart from the light source at a predetermined distance to reflect the light emitted from the light source toward the print medium, a mirror unit to reflect the light reflected from the print medium in a predetermined path, a lens unit disposed along a light path of the light reflected from the mirror unit, and a reading member to detect the light passing through the lens unit and to read the information about the malfunctioning nozzle from the print medium, in which the light source, the reflection unit, the mirror unit, the lens unit, and the reading member are installed in the case.

The detecting unit may radiate complementary color lights onto the first and second test print patterns to increase an efficiency of the detection of the malfunctioning nozzle.

The detecting of the group of nozzles having the malfunctioning nozzle may include: detecting the first test print patterns a number of times n, where n is an integer; and counting a number of times z, where z is an integer, of the number of times n that a detected voltage is higher that a threshold voltage for a predetermined location on the print medium corresponding to a nozzle of the group of nozzles having the malfunctioning nozzle.

An efficiency of the detection of the malfunctioning nozzle is enhanced by controlling the threshold voltage.

The method may further include, after detecting the position of the malfunctioning nozzle, performing a maintenance operation to keep the malfunctioning nozzle in a standby state.

The foregoing and/or other aspects and utilities of the present general inventive concept may also be achieved by providing a detecting unit to detect a defective nozzle of a nozzle unit of an inkjet image forming apparatus, the detecting unit including a light emitting part to emit light towards a first print pattern and a second print pattern, a light receiving part to receive first light reflected from the first print pattern and to convert the received first light into first electrical signals, and to receive second light reflected from the second print pattern and to convert the received second light into second electrical signals, and a control part to determine whether the nozzle unit has a defective nozzle and a location of a group of nozzles including the defective nozzle when it is determined that the nozzle unit has a defective nozzle using the first electrical signals, and to detect a position of the defective nozzle among the group of nozzles using the second electrical signals.

The detecting unit may further include a reflecting unit to reflect the first and second light from the first and second print patterns, respectively, towards the light receiving part, and a focusing part to focus the first and second light reflected from the reflecting part to be incident on the light receiving part. The first print pattern may be generated by a plurality of groups of nozzles including the group of nozzles having the defective nozzle, and the second print pattern may be generated by the group of nozzles having the defective nozzle. An intensity of the first and second electric signals may vary according to an intensity of the reflected first and second light, respectively, and the intensity of the reflected first and second light may vary according to an ink concentration on the first and second print patterns, respectively. The control part may detect the location of the group of nozzles having the defective nozzle by analyzing the intensity of the first electrical signals using a first predetermined threshold intensity. The control part may detect the location of the group of nozzles having the defective nozzle by identifying an electrical signal of the first electrical signals that has an intensity above the predetermined threshold intensity. The control part may detect the position of the defective nozzle by analyzing the intensity of the second electrical signals using a second predetermined threshold intensity and generating a signal including information about the position of the defective nozzle based on the analysis.

The foregoing and/or other aspects and utilities of the present general inventive concept may also be achieved by providing an inkjet image forming apparatus, including a conveying unit to convey a print medium in a conveying direction, a nozzle unit comprising a plurality of groups of nozzles to eject ink onto the print medium, and a detecting unit downstream of the nozzle unit in the conveying direction to detect whether the nozzle unit has a defective nozzle using first electrical signals corresponding to a first printed pattern and a location of a group of nozzles including the defective nozzle when it is determined that the nozzle unit has a defective nozzle using the first electrical signals, and to detect a position of the defective nozzle in the group of nozzles including the defective nozzle using second electrical signals corresponding to a second printed pattern.

The inkjet image forming apparatus may further include a driving unit to drive the plurality of groups of nozzles to generate the first printed pattern, and to drive the group of nozzles having the defective nozzle to generate the second printed pattern. The driving unit may sequentially drive each nozzle of the group of nozzles having the defective nozzle for a predetermined time period to generate the second printed pattern. The inkjet image forming apparatus may further include a maintenance unit to perform maintenance on at least the defective nozzle. The detecting unit may detect the position of the defective nozzle by analyzing an intensity of the second electrical signals using a predetermined threshold intensity and generating a signal including information about the position of the defective nozzle using the analysis. The inkjet image forming apparatus may further include a memory to store the information about the position of the defective nozzle. The inkjet image forming apparatus may further include a control unit to compensate for the defective nozzle using the information about the position of the defective nozzle.

The foregoing and/or other aspects and utilities of the present general inventive concept may also be achieved by providing a method of detecting a position of a defective nozzle of a nozzle unit including a plurality of groups of nozzles of an inkjet image forming apparatus, the method including detecting a location of a group of nozzles of the plurality of groups of nozzles that includes the defective nozzle using a first print result, and detecting the position of the defective nozzle in the group of nozzles that includes the defective nozzle unit using a second print result.

The detecting of the location may include determining whether the plurality of groups of nozzles has a the group of nozzles that include the defective nozzle using first electrical signals corresponding to the first print result, and detecting the location of the group of nozzles that includes the defective nozzle when it is determined that the nozzle unit has the defective nozzle using the first electrical signals. The detecting of the position may include detecting a position of the defective nozzle in the group of nozzles that includes the defective nozzle using second electrical signals corresponding to the second print result. The method may further include driving the plurality of groups of nozzles to generate the first print result, and driving only the group of nozzles having the defective nozzle to generate the second print result. The detecting the location of the group of nozzles that includes the defective nozzle may include comparing intensities of the first electrical signals to a first predetermined threshold intensity, and identifying an electric signal of the first electric signals that has an intensity above the predetermined threshold intensity. The detecting of the position of the defective nozzle may include comparing intensities of the second electrical signals to a second predetermined threshold intensity, and generating an information signal including the position of the defective nozzle in the group of nozzles that includes the defective nozzle using the comparison.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view illustrating an inkjet image forming apparatus, according to an embodiment of the present general inventive concept;

FIG. 2 is a view illustrating a detecting unit of the inkjet image forming apparatus of FIG. 1, according to an embodiment of the present general inventive concept;

FIG. 3 is a perspective view illustrating the detecting unit of the inkjet image forming apparatus of FIG. 1, according to another embodiment of the present general inventive concept;

FIG. 4 is a side sectional view illustrating the detecting unit of FIG. 3;

FIG. 5 is a view illustrating a printhead unit of the inkjet image forming apparatus of FIG. 1, according to an embodiment of the present general inventive concept;

FIG. 6 is a view illustrating a driving mechanism of a printhead of the inkjet image forming apparatus of FIG. 1, according to an embodiment of the present general inventive concept;

FIG. 7 is a block diagram illustrating an image forming system, according to an embodiment of the present general inventive concept;

FIG. 8 is a block diagram illustrating a structure of an inkjet image forming apparatus, according to an embodiment of the present general inventive concept;

FIG. 9 is a flow chart illustrating a method of detecting a malfunctioning nozzle, according to an embodiment of the present general inventive concept;

FIG. 10 is a view illustrating first test print patterns, according to an embodiment of the present general inventive concept;

FIG. 11 is a partly enlarged view illustrating black printing patterns of FIG. 10;

FIG. 12 is a view illustrating a method of detecting a group of nozzles having a malfunctioning nozzle from the first test print patterns of FIG. 10;

FIG. 13 is a view illustrated second test print patterns, according to an embodiment of the present general inventive concept; and

FIG. 14 is a view illustrating a method of detecting a position of a malfunctioning nozzle using the second test print patterns of FIG. 13.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An inkjet image forming apparatus including a printhead and a method of compensating for a malfunctioning nozzle according to embodiments of the present general inventive concept will now be described more fully with reference to the accompanying drawings, in which exemplary embodiments of the general inventive concept are illustrated. In the drawings, thicknesses and sizes of lines may be exaggerated for clarity and convenience.

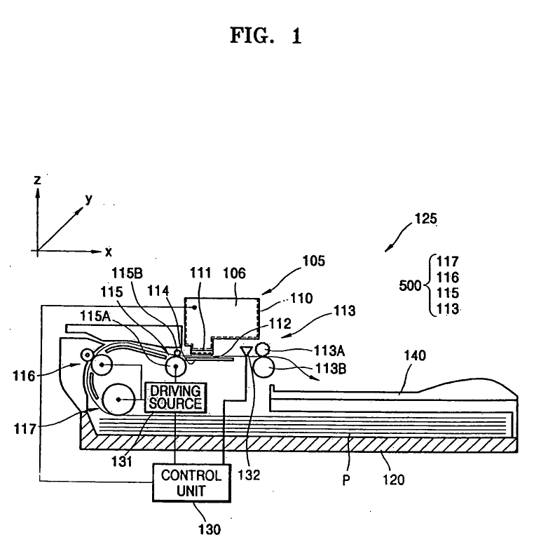

FIG. 1 is a view illustrating an inkjet image forming apparatus, according to an embodiment of the present general inventive concept.

Referring to FIG. 1, the inkjet image forming apparatus 125 includes a feeding cassette 120, a printhead unit 105, a supporting member 114 opposite to the printhead unit 105, a detecting unit 132 to detect a malfunctioning (i.e., defective) nozzle, a print medium transferring unit 500 to transfer a print medium P in a first direction, i.e., an x direction, and a stacking unit 140 on which discharged print medium P is stacked. In addition, the inkjet image forming apparatus 125 further includes a control unit 130 to control each component thereof.

The print medium P can be stacked on the feeding cassette 120. The print medium P can be transferred from the feeding cassette 120 through a printhead 111 to the stacking unit 140 by the print medium transferring unit 500, which will be described later.

The print medium transferring unit 500 transfers the print medium P along a predetermined path and includes a pick-up roller 117, an auxiliary roller 116, a feeding roller 115, and a discharging roller 113. The print medium transferring unit 500 can be driven by a driving source 131, such as a motor, and provides a transferring force to transfer the print medium P. The driving source 131 is controlled by the control unit 130, which will be described later. That is, the control unit 130 controls the driving source 131 to set a speed of the print medium P.

The pick-up roller 117 is installed in one side of the feeding cassette 120 and picks up the print medium P stacked in the feeding cassette 120. The feeding roller 115 is installed at an inlet side of the printhead 111 and feeds the print medium P drawn out by the pick-up roller 117 to the printhead 111. The feeding roller 115 includes a driving roller 115A to supply a transferring force to transfer the print medium P, and an idle roller 115B elastically engaged with the driving roller 115A. The auxiliary roller 116 to transfer the print medium P may be further installed between the pick-up roller 117 and the feeding roller 115. The discharging roller 113 is installed at an outlet side of the printhead 111 and discharges the print medium P on which the printing has been completed to an outside of the inkjet image forming apparatus 125. The discharged print medium P is stacked on the stacking unit 140.

The discharging roller 113 includes a star wheel 113A installed in a width direction of the print medium P, and a supporting roller 113B, which is opposite to the star wheel 113A and supports a rear side of the print medium P. The print medium P may wrinkle due to ink ejected onto a top side thereof while passing through a nozzle unit 112. A distance between the print medium P and the nozzle unit 112 may not be maintained due to the wrinkles of the print medium P. The star wheel 113A prevents the print medium P fed in a downward direction of the nozzle unit 112 from contacting a bottom surface of the nozzle unit 112 or a body 110 of the printhead unit 105, and/or prevents the distance between the print medium P and the bottom surface of the nozzle unit 112 or the body 110 from being changed. The star wheel 113A is installed such that at least a portion of the star wheel 113A protrudes from the nozzle unit 112, and contacts at a point on a top surface of the print medium P.

The supporting member 114 is installed below the printhead 111 and supports a bottom side of the print medium P to maintain a predetermined distance between the nozzle unit 112 and the print medium P. The distance between the nozzle unit 112 and the print medium P can be about 0.5 to about 2.5 mm.

The detecting unit 132 detects a malfunctioning nozzle which is generated, for example, in a manufacturing process or during printing. The malfunctioning nozzle can be a poorly-ejecting or non-ejecting nozzle. That is, the malfunctioning nozzle exists when ink is not ejected from nozzles due to one or more causes or when a smaller amount of ink droplets is ejected as compared to a non-malfunctioning (i.e., normal or non-defective) nozzle. The malfunctioning nozzle can be generated in a process of manufacturing the printhead 111 or during printing. In general, information on the malfunctioning nozzle generated in the manufacturing process is stored in a memory (not illustrated) installed in the printhead 111. The information can be transmitted to the inkjet image forming apparatus 125 when the printhead 111 is mounted in the inkjet image forming apparatus 125.

A printhead of an inkjet image forming apparatus is classified into two types according to an actuator that provides an ejecting force to ink droplets: thermal driving and piezoelectric driving. With respect to thermal driving, defects in a heater used to eject ink, such as a disconnection of the heater or a break in a driving circuit of the heater, or malfunctions of nozzles due to damage to an electrical element, such as a field emission transistor (FET), and the like can be easily detected. Likewise, with respect to piezoelectric driving, defects of a piezoelectric device or malfunctions of nozzles due to damage to a driving circuit of the piezoelectric device can be easily detected.

However, a cause of a malfunctioning nozzle may not be easily detected when the malfunctioning nozzle is clogged with foreign matters. When a cause of a malfunctioning nozzle cannot be easily detected, test printing can be performed to detect the malfunctioning nozzle. If a malfunctioning nozzle exists in the nozzle unit 112, resulting in a decrease in a number of ink droplets ejected from the malfunctioning nozzle, an ink concentration on a portion of a print medium P printed by the malfunctioning nozzle is lower than on a portion of the print medium P printed by a normal nozzle. The detecting unit 132 detects the malfunctioning nozzle using a concentration difference between a region printed by a normal nozzle and a region printed by a malfunctioning nozzle when test printing is performed.

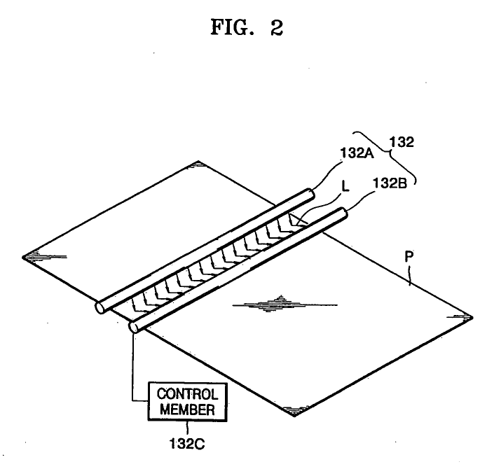

FIG. 2 is a view illustrating the detecting unit 132 of the inkjet image forming apparatus 125 of FIG. 1, according to an embodiment of the present general inventive concept. Referring to FIG. 2, the detecting unit 132 includes a light emitting unit 132A to radiate light L onto the print medium P and a light receiving unit 132B to receive the light L reflected from the print medium P. The detecting unit 132 senses a difference in an intensity of the light L reflected from the print medium P, and thereby detects a position of a malfunctioning nozzle. The detecting unit 132 is disposed along a width direction of the print medium P. The light L is emitted from the light emitting unit 132A onto the print medium P, and the light receiving unit 132B receives the light L reflected from the print medium P. That is, the light L emitted from the light emitting unit 132A is reflected from the print medium P and the light receiving unit 132B receives the light L reflected from the print medium P. When a malfunctioning nozzle exists, an intensity of light L received by the light receiving unit 132B is changed, and thus a position of the malfunctioning nozzle can be detected. The light emitting unit 132A may be, for example, a light emitting diode, and the light receiving unit 132B may be, for example, a photo sensor.

The detecting unit 132 may further include a control member 132C. The control member 132C can compare a sensing current from the light receiving unit 132B with a predetermined value, and uses the comparison result to generate an information signal including the position of the malfunctioning nozzle. The detecting unit 132 receives the signal generated from the control member 132C and detects the position of the malfunctioning nozzle.

As describe above, the information including the position of the malfunctioning nozzle detected by the detecting unit 132 can be stored in an additional memory (not illustrated), and transmitted to the control unit 130, which will be described later.

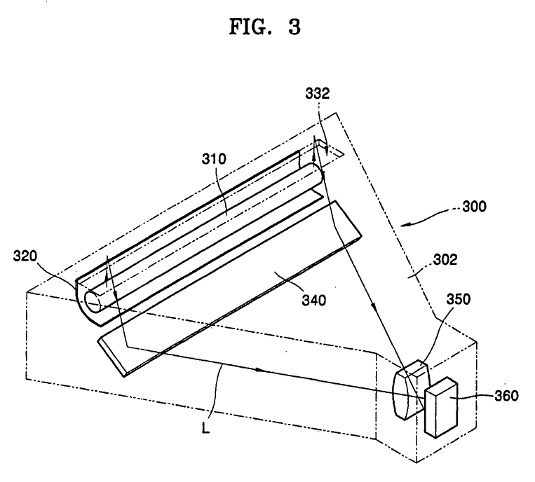

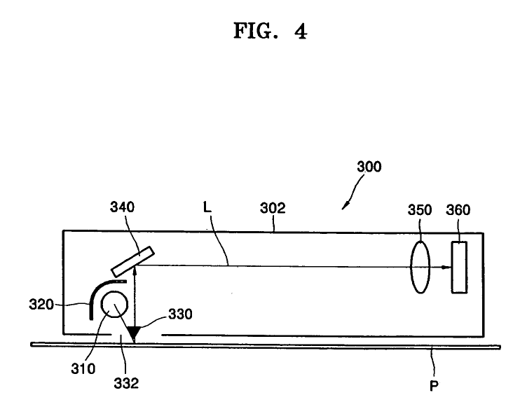

FIG. 3 is a perspective view illustrating the detecting unit 132 of the inkjet image forming apparatus 125 of FIG. 1, according to another embodiment of the present general inventive concept. FIG. 4 is a side sectional view illustrating the detecting unit 132 of FIG. 3. Referring to FIGS. 1, 3, and 4, the detecting unit 132 includes a reading unit 300 to read information about a malfunctioning nozzle by radiating light L onto the print medium P on which ink is ejected through the nozzle unit 112 and to receive the light L reflected from the print medium P.

For example, the reading unit 300 may be installed between the nozzle unit 112 and the discharging roller 113, may radiate light to a top surface of the print medium P that passed under the nozzle unit 112, may receive the light L reflected from the print medium P, and may convert the light L reflected from the print medium P into electric signals, thereby reading the information about the malfunctioning nozzle from the print medium P. The reading unit 300 includes a case 302, and also includes a light source 310, a reflection unit 320, a mirror unit 340, a lens unit 350, and a reading member 360, which are installed inside of the case 302.

The light source 310 emits the light L to scan the print medium P and a cold cathode fluorescent (CCF) lamp is used for the current embodiment illustrated in FIG. 3. However, the light source 310 is not limited to being the CCF lamp, and thus can be any other suitable light source. The reflection unit 320 is installed apart from the light source 310 at a predetermined distance and reflects the light L emitted from the light source 310 to the print medium P.

A reading hall 332 is formed at a position where the light L emitted from the light source 310 and the light L reflected from the reflection unit 320 meet a printing face of the print medium P in a predetermined transferring direction. A reading point 330 where information about the printing face of the print medium P is read is formed within range of the reading hall 332.

The mirror unit 340 reflects the light L reflected from the print medium P passing the reading hall 332 toward the lens unit 350, which will be described later. To reduce a thickness of the reading unit 300, the mirror unit 340 may include a single mirror.

The lens unit 350 is disposed along a light path of the light L reflected from the mirror unit 340. The light L passing through the lens unit 350 is incident on the reading member 360. The reading member 360 detects an intensity of the light L which is reflected from the printing face of the print medium P and passes through the lens unit 350, and converts the light L into electric signals, thereby reading the information to determine whether a malfunctioning nozzle exists. The reading member 360 may include a charge coupled device (CCD) having a desired focal depth. The reading member 360 may include a contact image sensor (CIS). The CIS and the CCD are well-known to those of ordinary skill in the art, and thus a detailed description thereof will be omitted. A reading member 360 other than the CIS and the CCD can be used as the reading member 360.

Referring to FIG. 3, the case 302 of the reading unit 300 may have a polyhedron shape. The light source 310, the reflection unit 320, and the mirror unit 340 are disposed on one side of the case 302. The lens unit 350 and the reading member 360 are disposed at a position corresponding to an apex of the polyhedron shape facing the one side of the case 302. When the reading unit 300 is formed as described above, the reading unit 300 can be miniaturized.

In embodiments, a nozzle inspection signal can be transmitted from the detecting unit 132 to each nozzle in the printhead 111, and thus whether a malfunctioning nozzle exists can be determined according to a response to the nozzle inspection signal.

The detecting unit 132 detects the position of the malfunctioning nozzle using the above-described series of processes. The information of the malfunctioning nozzle detected by the detecting unit 132 is stored in a memory (not illustrated), and the control unit 130 controls the operation of each component according to the information of the malfunctioning nozzle stored in the memory (not illustrated).

Referring back to FIG. 1, the printhead unit 105 prints an image by ejecting ink onto the print medium P. The printhead unit 105 includes the body 110, the printhead 111 installed in one side of the body 110, the nozzle unit 112 formed on the printhead 111, and a carriage 106 where the body 110 is mounted. The body 110 is mounted into the carriage 106 in a cartridge type manner. The feeding roller 115 is rotatably installed at an inlet side of the nozzle unit 112, and the discharging roller 113 is rotatably installed at an outlet side of the nozzle unit 112.

Although not illustrated, a removable cartridge type ink container can be provided in the body 110. Further, the body 110 may include chambers, each of which has ejecting units (for example, piezoelectric elements or heat-driving typed heaters) that are connected to respective nozzles of the nozzle units 112 and provide pressure to eject the ink, a passage (for example, an orifice) to supply the ink contained in the body 110 to each chamber, a manifold that is a common passage to supply the ink flown through the passage to the chamber, and a restrictor that is an individual passage to supply the ink from the manifold to each chamber. The chambers, the ejecting units, the passage, the manifold, and the restrictor are well-known to a person skilled in the art, and thus detailed descriptions thereof will be omitted. In addition, the ink container (not illustrated) may be separately installed from the printhead unit 105. The ink stored in the ink container may be supplied to the printhead unit 105 through a supplying unit, such as a hose.

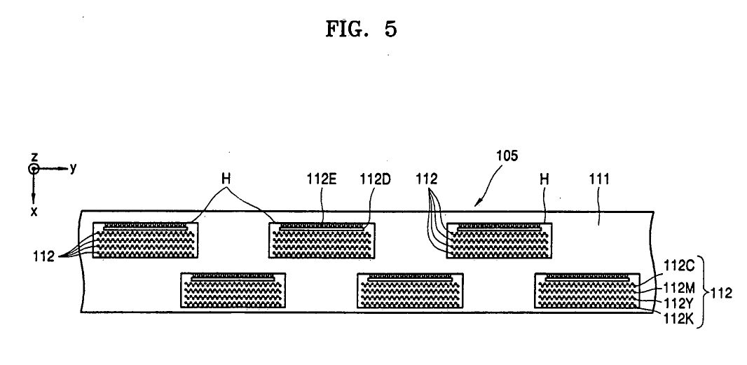

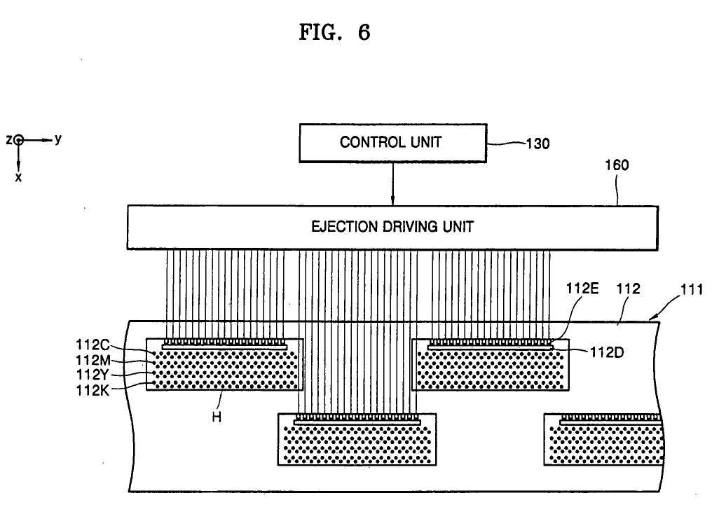

FIG. 5 is a view illustrating the printhead unit 105 of the inkjet image forming apparatus 125 of FIG. 1, according to an embodiment of the present general inventive concept. FIG. 6 is a view illustrating a driving mechanism of the printhead 111 of the inkjet image forming apparatus 125 of FIG. 1, according to an embodiment of the present general inventive concept.

Referring to FIG. 5 in conjunction with FIG. 1, the printhead 111 is installed along a second direction, i.e., a y direction, with respect to the print medium P transferring along the first direction, i.e., the x direction. The printhead 111 uses heat energy or a piezoelectric device as an ink ejecting source, and is made to have a high resolution through a semiconductor manufacturing process, such as etching, deposition or sputtering. The printhead 111 includes the nozzle unit 112 to eject ink onto the print medium P to form an image when the print medium P is transferred. The nozzle unit 112 may correspond to a width of the print medium P or may be longer than the width of the print medium P.

Referring to FIGS. 1 and 6, an ejection driving unit 160 provides an ejecting force to ink droplets, and drives the printhead 111 with a predetermined frequency to print the image on the print medium P. The ejection driving unit 160 can be classified into two types according to an actuator that provides an ejecting force to the ink droplets: a thermal driving printhead and a piezoelectric driving printhead. The thermal driving printhead generates bubbles in ink using a heater to eject ink droplets due to an expanding force of the bubbles. The piezoelectric driving printhead ejects ink droplets using a pressure applied to ink due to deformation of a piezoelectric device. The ejection driving unit 160 drives nozzles in the nozzle unit 112 and is controlled by the control unit 130, which will be described later.

As described above, the printhead 111 includes the nozzle unit 112 to print the image. The nozzle unit 112 may be mounted in the printhead 111 as a head chip H type or a line type. The nozzle unit 112 ejects ink of at least one color onto the print medium P to print the image. The nozzle arrays to eject ink of the same color may be arranged in a single longitudinal line or in two lines that cross each other (as illustrated in FIGS. 5 and 6) in the nozzle unit 112 of the head chip H. Hereinafter, the printhead 111 having various shapes will be described with reference to the accompanying drawings.

Referring to FIG. 5, a plurality of head chips H having a plurality of nozzle arrays 112C, 112M, 112Y, and 112K may be formed in the printhead 111. Each of the head chips H has a driving circuit which time-dividedly (e.g., sequentially or serially) drives nozzles of the corresponding nozzle unit 112 selectively (e.g., individually) or in groups of nozzles. When the plurality of head chips H are arranged in a single line, a distance between the plurality of head chips H may become greater than a distance between the nozzles in the same head chips H, thereby generating an unprinted portion on the printing medium P corresponding to the distance between the plurality of head chips H. Therefore, the plurality of head chips H may be arranged in a zigzag shape (as illustrated in FIGS. 5 and 6).

The nozzle arrays among the nozzle arrays 112C, 112M, 112Y, and 112K in the head chip H, which eject ink of the same color, may be disposed and cross one another to enhance printing resolution in the second direction, i.e., the y direction. In this case, ink dots ejected by the nozzles in the nozzle arrays are deposited on positions on the print medium P between ink dots ejected by the nozzles in the other nozzle arrays, thereby enhancing a printing resolution in the second direction, i.e., the y direction.

Each of the nozzles in the nozzle unit 112 includes a driving circuit 112D and a cable 112E to receive printing data, electric power, control signals, etc. The cable 112E may be, for example, a flexible printed circuit (FPC) or a flexible flat cable (FFC).

Although the printhead 111 having head chips H is described in the current embodiment, the printhead 111 may have various other structures. For example, the printhead 111 may be formed of a single head chip having a length equal to a width of the print medium P, in which a nozzle array corresponding to a width of the print medium P is arranged in the second direction, i.e., the y direction. The structure of the printhead 111 illustrated in the accompanying drawings thus does not limit the technical scope of the present general inventive concept.

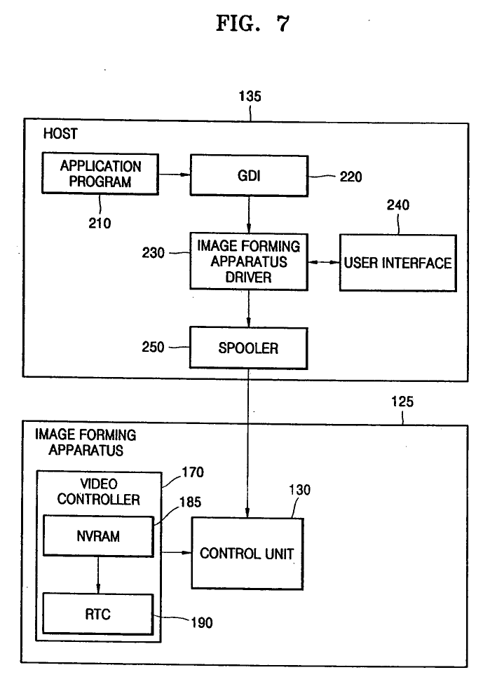

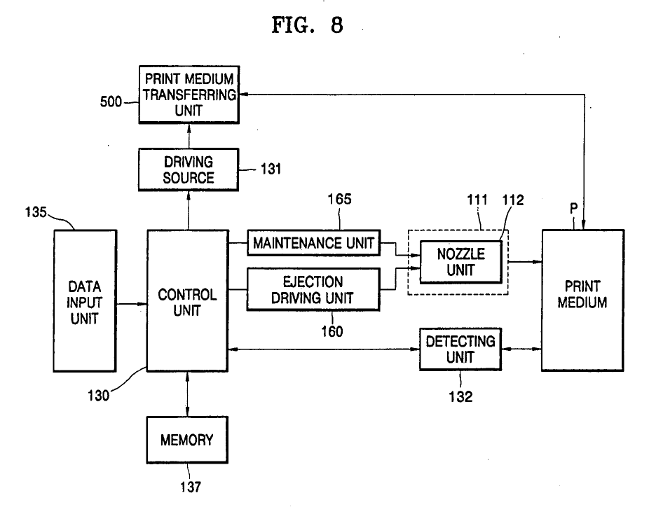

FIG. 7 is a block diagram illustrating an image forming system according to an embodiment of the present general inventive concept. FIG. 8 is a block diagram illustrating a structure of an inkjet image forming apparatus according to an embodiment of the present general inventive concept. The image forming system of FIG. 7 includes a data input unit 135 (i.e., a host system) and the inkjet image forming apparatus 125.

Referring to FIG. 7, the data input unit 135 is a host system, such as a personal computer (PC), a digital camera, or a personal digital assistant (PDA), and receives image data to be printed. The data input unit 135 includes an application program 210, a graphics device interface (GDI) 220, an image forming apparatus driver 230, a user interface 240, and a spooler 250.

The application program 210 generates and edits an object that can be printed by the inkjet image forming apparatus 125. The GDI 220 is a program installed in the host to receive the object from the application program 210, to send the received object to the image forming apparatus driver 230, and to generate commands related to the object in response to a request from the image forming apparatus driver 230. The image forming apparatus driver 230 is a program installed in the host to generate commands that can be interpreted by the inkjet image forming apparatus 125. The user interface 240 of the image forming apparatus driver 230 is a program installed in the computer system to provide environment variables with which the image forming apparatus driver 230 generates commands. The spooler 250 is a program installed in the operating system of the host to transmit the commands generated by the image forming apparatus driver 230 to an input/output device (not illustrated) that is connected to the inkjet image forming apparatus 125.

The inkjet image forming apparatus 125 includes a video controller 170, the control unit 130, and a printing environment information unit (not illustrated). The video controller 170 includes a non-volatile random access memory (NVRAM) 185, a static random access memory (SRAM, not illustrated), a synchronous dynamic random access memory (SDRAM) (not illustrated), a NOR Flash (not illustrated), and a real time clock (RTC) 190. The video controller 170 interprets the commands generated by the image forming apparatus driver 230 to convert the commands into corresponding bitmaps and transmits the bitmaps to the control unit 130. The control unit 130 transmits the bitmaps to each component of the inkjet image forming apparatus 125 to print an image on a print medium P. Through above described processes, the inkjet image forming apparatus 125 prints an image.

Referring to FIGS. 7 and 8, the control unit 130 is mounted on a motherboard (not illustrated) of the inkjet image forming apparatus 125, and controls a maintenance operation of the nozzle unit 112 installed in the printhead 111 when a malfunctioning nozzle is detected, an ejecting operation of the nozzle unit 112, and a transferring operation of the print medium transferring unit 500. The control unit 130 synchronizes the operation of each component of the inkjet image forming apparatus 125 so that the detecting unit 132 is operated to detect a malfunctioning nozzle, a maintenance unit 165 is operated when a malfunctioning nozzle is detected, and ink ejected from the nozzle unit 112 can be deposited on a desired area of the print medium P. In addition, the control unit 130 stores image data input through the data input unit 135 in a memory 137, and determined whether the image data desired to be printed is completely stored in the memory 137.

The inkjet image forming apparatus 125 includes the maintenance unit 165. The maintenance unit 165 maintains the printhead 111 in a standby state, and can include a wiping member (not illustrated) to wipe the nozzle unit 112 in the printhead 111, a waste ink reservoir (not illustrated) to store ink spitted from the nozzle unit 112 when a spitting operation is performed. The operations of the maintenance unit 165 include suction, wiping, and spitting operations.

In the suction operation, ink remaining in holes of the nozzles of the printhead 111 is sucked to clean the holes. In the wiping operation, ink remaining on a surface of the nozzle unit 112 is wiped. In the spitting operation, a small amount of ink is ejected from the printhead 111 in advance. That is, the small amount of ink is spitted through ink ejecting nozzles of the printhead 111 before or during printing to prevent an unusual ink ejection because of dried ink. Structures and functions of the maintenance unit 165 are well-known to those of ordinary skill in the art, and thus a detailed description thereof will be omitted.

Hereinafter, a method of detecting a malfunctioning nozzle according to an embodiment of the present general inventive concept will be described in conjunction with the operation of the control unit 130.

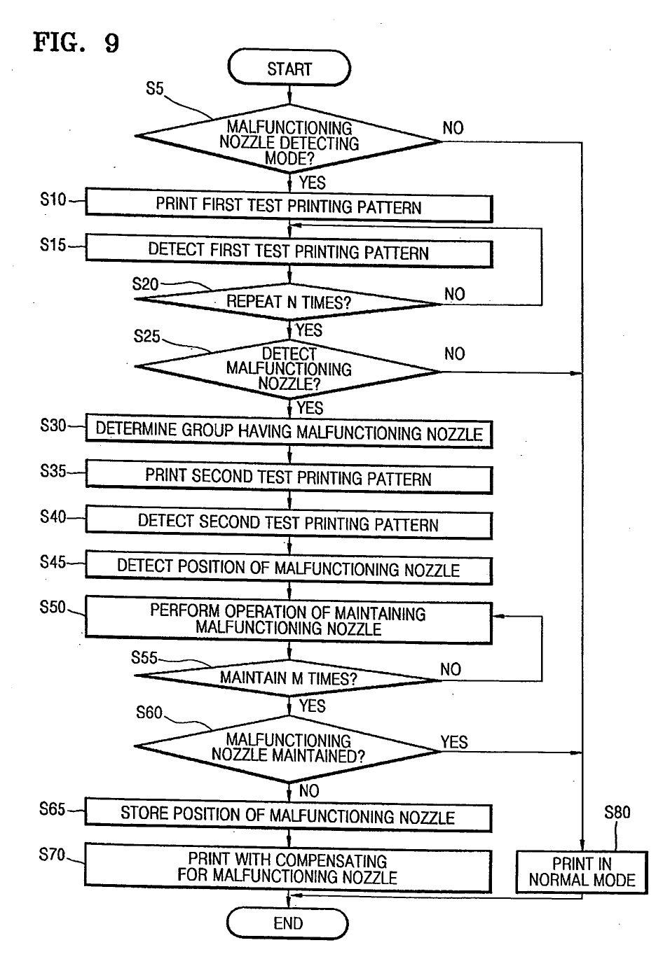

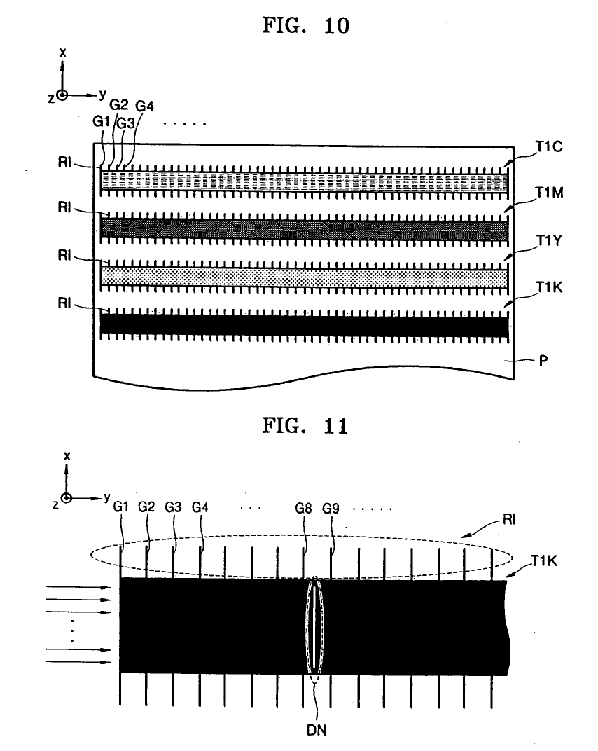

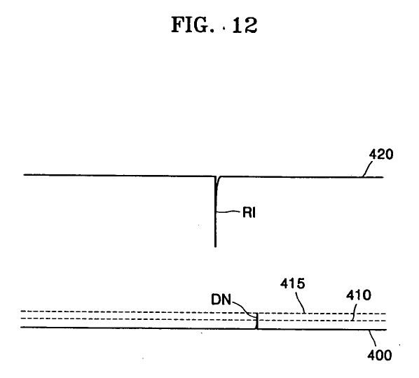

FIG. 9 is a flow chart illustrating a method of detecting a malfunctioning nozzle according to an embodiment of the present general inventive concept. FIG. 10 is a view illustrating first test print patterns according to an embodiment of the present general inventive concept. FIG. 11 is a partly enlarged view illustrating black printing patterns of FIG. 10.

Referring to FIGS. 7 through 9, the inkjet image forming apparatus 125 receives image data to be printed from the host, i.e., the data input unit 135. When a user finds a problem regarding an image quality of the image data or when the detecting unit 132 detects a signal which is possibly related to a presence of a malfunctioning nozzle, a malfunctioning nozzle detecting process begins to operate in operation S5. The method of detecting a malfunctioning nozzle of this embodiment can be performed according to a user's selection or can be automatically performed when the signal detected by the detecting unit 132 is transmitted to the control unit 130. When a malfunctioning nozzle is not detected, or when a malfunctioning nozzle detection mode is not in use, printing is performed in a normal mode in operation S80. Otherwise, when a malfunctioning nozzle is detected, subsequent operations are performed, as illustrated in FIG. 9.

The method of detecting a malfunctioning nozzle of this embodiment includes printing first test print patterns to detect a group of nozzles having the malfunctioning nozzle in operation S10, detecting the group of nozzles having the malfunctioning nozzle from the first test print patterns by the detecting unit 132 in operations S15, S20, S25, and S30, printing second test print patterns to detect a position of the malfunctioning nozzle in the group of nozzles in operation S35, and detecting the position of the malfunctioning nozzle in the nozzle unit 112 from the first and second test print patterns by the detecting unit 132 in operations S40, S45, and S50. Hereinafter, each of the operations will be described in detail with reference to the accompanying drawings.

Referring to FIGS. 8 through 10, the control unit 130 controls the ejection driving unit 160 to print the first test print patterns, e.g., the first test print patterns T1C, T1M, T1Y, and T1K of FIG. 10, to detect the group of nozzles having the malfunctioning nozzle in operation S10. The nozzle unit 112 according to an embodiment of the present general inventive concept has a length corresponding to the width of the print medium P, and thus it is not easy to detect the position of the malfunctioning nozzle. Accordingly, in order to accurately detect the position of the malfunctioning nozzle, the control unit 130 divides each of the nozzle units 112 into a predetermined number of groups of nozzles, such as the groups G1, G2, G3, G4, etc. illustrated in FIG. 10. The first test print patterns printed by the divided nozzle units 112 are illustrated in FIG. 10. The control unit 130 also controls the ejection driving unit 160 to print reference indicators RI to indicate positions of the groups of nozzles with respect to the first test print patterns T1C, T1M, T1Y, and T1K such that the detecting unit 130 can easily detect the positions of the groups G1, G2, G3, G4, etc. The reference indicators RI can be lines having a predetermined length in the transferring direction of the print medium P, i.e., the x direction, and can be spaced apart from each other in the width direction of the print medium P, i.e., the y direction.

Referring to FIGS. 8 through 11, the detecting unit 132 scans the first test print patterns T1C, T1M, T1Y, and T1K to detect the group of nozzles having the malfunctioning nozzle in operation S15. The reference indicators RI among the first test print patterns T1C, T1M, T1Y, and T1K are first scanned by the detecting unit 132. The scanned reference indicators RI are stored in an additional memory (not illustrated). Next, the detecting unit 132 scans the first test print patterns T1C, T1M, T1Y, and T1K to detect the group of nozzles having the malfunctioning nozzle. The accurate (e.g., the exact) position of the malfunctioning nozzle is not detected from the first test print patterns T1C, T1M, T1Y, and T1K, and the group of nozzles having the malfunctioning nozzle is instead detected because it is not easy to detect the accurate position of the malfunctioning nozzle using the detecting unit 132 (such as a scanner installed in the inkjet image forming apparatus 125). If an expensive detecting unit is used, the position of the malfunctioning nozzle can be detected from a first test print pattern(s), but the manufacturing cost of the inkjet image forming apparatus undesirably increases. As describe above, the group of nozzles having the malfunctioning nozzle may be detected in advance using the reference indicators RI.

FIG. 12 is a view illustrating a method of detecting a group of nozzles having a malfunctioning nozzle from the first test print patterns of FIG. 10. FIG. 12 illustrates voltage signals of the first test print patterns of FIG. 11 using a CCD reading unit as the detecting unit 132.

Referring to FIGS. 8 through 12, when the detecting unit 132 scans the print medium P, a constant output voltage 420 is generated. However, when the detecting unit 132 scans the reference indicators RI colored in black, the output voltage 420 drops due to a change in an of reflected light. Then, light intensities of the nozzle groups are stored in a memory (not illustrated). When the detecting unit 132 scans the printed regions on the print medium P, an output voltage 400 is generated. When a malfunctioning nozzle exists, an ink concentration on a region of the print medium P printed by the malfunctioning nozzle is different from ink concentrations on regions printed with the normal nozzles. Accordingly, when the detecting unit 132 scans the region printed by the malfunctioning nozzle, a malfunctioning nozzle detecting signal DN is generated, as illustrated in FIG. 12. Since the malfunctioning nozzle detecting signal DN has a voltage 415 higher than a threshold voltage level 410, the group of nozzles having the malfunctioning nozzle can be detected. Here, the threshold voltage 410 is a reference voltage to detect a malfunctioning nozzle. Accordingly, the detecting unit 132 detects the group of nozzles having the malfunctioning nozzle based on the threshold voltage 410.

However, even when a malfunctioning nozzle does not exist, a voltage higher than the threshold voltage 410 can be generated due to, for example, noise. Thus, noise can result in a false-positive determination, which indicates that a malfunctioning nozzle exists when, in fact, no malfunctioning nozzle exists. To minimize a detection error (e.g., the false-positive) due to the noise, the first test print pattern T1K is detected n times in operation S20.

Whether the detecting signal DN is due to a malfunctioning nozzle or noise is determined by counting a number of times that the detecting signal DN having the voltage 415 higher that the threshold voltage 410 is detected in operation S25. When the number of times that the detecting signal DN having the voltage 415 higher that the threshold voltage 410 is detect is greater than or equal to 70% of n, the detecting signal DN is determined to be caused by a malfunctioning nozzle. Conversely, when the number of times is less than 70% of n, the detecting signal DN is determined to be caused by noise.

If the threshold voltage 410 is higher than the voltage 415 generated when a malfunctioning nozzle exists (in contrast to FIG. 12), the malfunctioning nozzle may not be detected. Thus, a threshold voltage set below a voltage generated by a malfunctioning nozzle can result in a false-negative determination, which indicates that a malfunctioning nozzle does not exist when, in fact, a malfunctioning nozzle exists. Accordingly, the threshold voltage 410 may be controlled according to the ink color to be printed, such that an efficiency of detecting a malfunctioning nozzle is enhanced. The voltage 400 output when the printing region is scanned is varied according to the colors. When the threshold voltage 410 is controlled to be close to the voltage 400 output according to the colors, an efficiency of detecting a group of nozzles having a malfunctioning nozzle can be enhanced.

To increase the efficiency of detecting a group of nozzles having a malfunctioning nozzle, the detecting unit 132 may use complementary color light to radiate the first test print patterns T1C, T1M, T1Y, and T1K. For example, one of white, red, green, and blue light can be radiated onto the black test print pattern T1K to detect a group of nozzles having a malfunctioning nozzle. The red light can be radiated onto the cyan test print pattern TC1, the green light can be radiated onto the magenta test print pattern T1M, and the blue light can be radiated onto the yellow test print pattern T1Y to detect a group of nozzles having a malfunctioning nozzle, resulting in an increase the efficiency of detecting a group of nozzles having a malfunctioning nozzle.

As described above, the group of nozzles having the malfunctioning nozzle is determined in operation S30. After determining the group of nozzles having the malfunctioning nozzle, the position of the malfunctioning nozzle in the group of nozzles having the malfunctioning nozzle is detected.

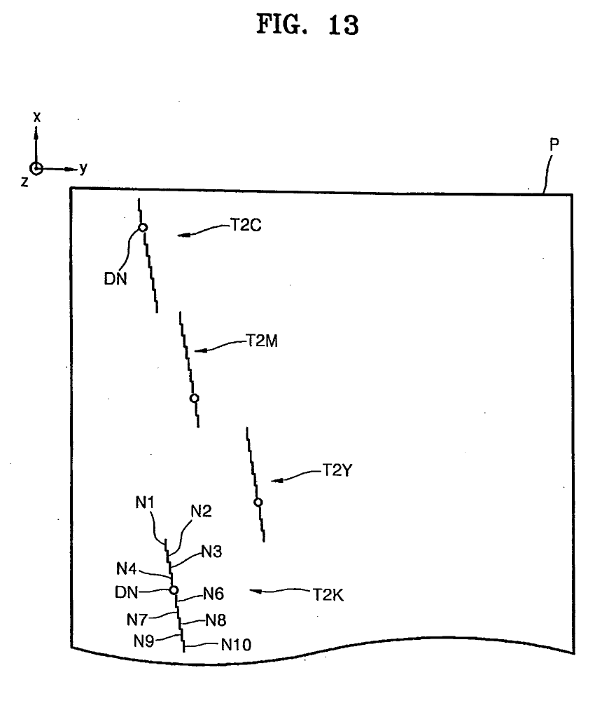

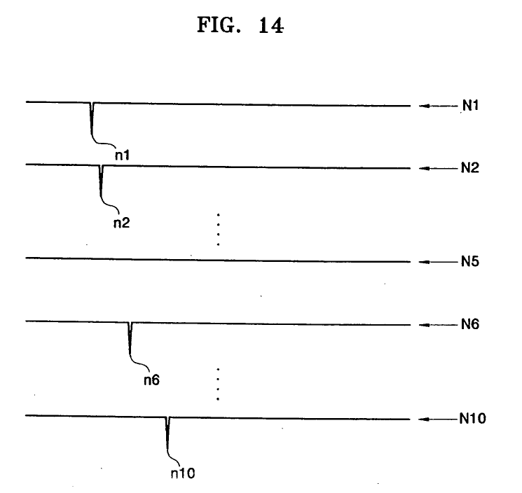

FIG. 13 is a view illustrating second test print patterns according to an embodiment of the present general inventive concept. FIG. 14 is a view illustrating a method of detecting a position of a malfunctioning nozzle using the second test print patterns of FIG. 13.

Referring to FIGS. 8, 9, and 13, to detect the position of the malfunctioning nozzle in the group of nozzles having the malfunctioning nozzle, the control unit 130 controls the ejection driving unit 160 to print second test print patterns T2C, T2M, T2Y, and T2K in operation S35. Here, the second test print patterns T2C, T2M, T2Y, and T2K may be printed only by the group of nozzles having the malfunctioning nozzle, as illustrated in FIG. 13. The control unit 130 may sequentially drive the nozzles in the group of nozzles having the malfunctioning nozzle at predetermined time intervals and starting from a first nozzle in order to print the second test print patterns T2C, T2M, T2Y, and T2K in operation S35 such that the detecting unit 132 detects the position of the malfunctioning nozzle in the group of nozzles in operation S40, as illustrated in FIG. 13.

For convenience of explanation, the black print pattern T2K among the second test print patterns T2C, T2M, T2Y, and T2K in FIG. 13 will be described as an example. In FIG. 13, the nozzles in the nozzle unit 112 are grouped in units of ten nozzles.

Referring to FIGS. 8, 13, and 14, a nozzle N1 is a normal nozzle, and thus printing by the nozzle N1 is normal. In particular, a black color is printed on the printing medium P corresponding to the nozzle N1, as illustrated in FIG. 13. When the print medium P passes a detecting region where the detecting unit 132 performs a detecting operation, the detecting unit 132 generates a signal n1 corresponding to the black color printed by the nozzle N1, as illustrated in FIG. 14. Next, the detecting unit 132 generates a signal n2 corresponding to a black color printed by a nozzle N2, which is also a normal nozzle. This process is repeated for each nozzle of the group if nozzles having the malfunctioning nozzle. Accordingly, signals n1-n4 and n6-n10 corresponding to normal nozzles N1-N4 and N6-N10 are generated, as illustrated in FIG. 14.

When the malfunctioning nozzle exists, the malfunctioning nozzle applied ink at a low concentration or no ink at all to the print medium P, as illustrated by DN in FIG. 13. Accordingly, the detecting unit 132 generates no signal or a relatively weak signal corresponding to regions of the print medium P that are printed by the malfunctioning nozzle, for example, N5 in FIGS. 13 and 14. That is, a signal difference exists between the regions corresponding to the normal nozzles and the region corresponding to the malfunctioning nozzle such that the detecting unit 132 detects the position of malfunctioning nozzle using the signal difference. Like when detecting the first test print patterns T1C, T1M, T1Y, and T1K, to increase an efficiency of detecting the position of the malfunctioning nozzle, the detecting unit 132 may use complementary color lights to radiate the second test print patterns T2C, T2M, T2Y, and T2K.

As describe above, a method of detecting a malfunctioning nozzle of an inkjet image forming apparatus according to embodiments of the present general inventive concept detects a group of nozzles having the malfunctioning nozzle from first test print patterns, and accurately detects a position of the malfunctioning nozzle from second test print patterns. Information about the detected position of malfunctioning nozzle can be stored in a memory (not illustrated). When a malfunctioning nozzle exists, a printing quality is degraded. However, the printing quality may be restored recovering (e.g., fixing or maintaining) or compensating for the malfunctioning nozzle.

Referring to FIGS. 8 and 9, when a malfunctioning nozzle exists, the control unit 130 can control the maintenance unit 165 to maintain the malfunctioning nozzle, or the group of nozzles having the malfunctioning nozzle, in a standby state in operation S50. In addition, the maintenance operation may be repeatedly performed for a predetermined number of times M for the malfunctioning nozzle or the group of nozzles having the malfunctioning nozzle in operation S55. After performing the maintenance operation, the detecting unit 132 detects the malfunctioning nozzle to determine whether the malfunctioning nozzle is maintained in the standby state in operation S60. When the malfunctioning nozzle is maintained in the standby state, the control unit 130 controls the inkjet image forming apparatus 125 to print in the normal mode in operation S80. Otherwise, when the malfunctioning nozzle is not maintained in the standby state, information about the position of malfunctioning nozzle is stored in a memory (not illustrated) in operation S65, and then the printing is performed by compensating for the malfunctioning nozzle according to the stored information in operation S70. A malfunctioning nozzle is compensated for by, for example, oscillating the printhead 111 or using an error diffusion method.

As described above, an inkjet image forming apparatus and a method of detecting a malfunctioning nozzle thereof, according to various embodiments of the present general inventive concept, can easily detect a position of a malfunctioning nozzle using two kinds of test print patterns.

Also as describe above, an inkjet image forming apparatus and a method of detecting a malfunctioning nozzle thereof, according to various embodiments of the present general inventive concept, can accurately detect a position of a malfunctioning nozzle for a line printing type inkjet image forming apparatus without using an expensive detecting unit. Unlike a shuttle type inkjet image forming apparatus, the line printing inkjet image forming apparatus includes a nozzle unit with a length corresponding to a width of a print medium and thus it is not easy to detect a malfunctioning nozzle. A group of nozzles having a malfunctioning nozzle can be detected from first test print patterns and the position of the malfunctioning nozzle can be detected from second test print patterns. Since the malfunctioning nozzle is detected using the two kinds of the test print patterns, the malfunctioning nozzle is easily detected even when an inexpensive detecting unit is used. In addition, according to various embodiments of the present general inventive concept, a user-selected maintenance operation or a self-diagnostic test can be performed when the malfunctioning nozzle is detected, thereby enhancing a lifetime of a corresponding printhead.

In addition, according to various embodiments of the present general inventive concept, when a detected malfunctioning nozzle is not maintained in a standby state, information about the detected malfunctioning nozzle can be stored in a memory, and thus the information about the malfunctioning nozzle can be supplied to compensate for the malfunctioning nozzle during subsequent printing operations.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
a printhead having a nozzle unit and having a length corresponding to a width of a print medium or longer;
an ejection driving unit to drive the printhead to print an image on the print medium;
a control unit to generate control signals to print first test print patterns to detect a group of nozzles having a malfunctioning nozzle after dividing nozzles of the nozzle unit into a predetermined number of groups of nozzles, and second test print patterns to detect a position of the malfunctioning nozzle in the group of nozzles having the malfunctioning nozzle; and
a detecting unit to detect the position of the malfunctioning nozzle in the nozzle unit using the first and second test print patterns.

2. The inkjet image forming apparatus of claim 1, wherein the control unit controls the printhead to print reference indicators to indicate locations of the groups of nozzles in the first test print patterns such that the detecting unit can detect the locations of the groups of nozzles.

3. The inkjet image forming apparatus of claim 2, wherein the reference indicators are lines having a predetermined length in a transferring direction of the print medium, and are spaced apart from each other in the width direction of the print medium.

4. The inkjet image forming apparatus of claim 1, wherein the control unit controls the ejection driving unit to sequentially drive the nozzles of the group of nozzles having the malfunctioning nozzle at predetermined time intervals and starting from a first nozzle in order to print the second test print patterns such that the detecting unit can detect the position of the malfunctioning nozzle in the group of nozzles having the malfunctioning nozzle.

5. The inkjet image forming apparatus of claim 1, wherein the detecting unit comprises:
a light emitting unit to radiate light onto the print medium; and
a light receiving unit to receive light reflected from the print medium.

6. The inkjet image forming apparatus of claim 1, wherein the detecting unit comprises:
a reading unit to radiate light onto the print medium on which ink is ejected when passing through the nozzle unit, to detect light reflected from the print medium, and to read information about a malfunctioning nozzle from the print medium.

7. The inkjet image forming apparatus of claim 6, wherein the reading unit comprises:
a case;
a light source emitting light to emit light onto the print medium;
a reflection unit which is installed apart from the light source at a predetermined distance and to reflect the light emitted from the light source toward the print medium;
a mirror unit to reflect the light reflected from the print medium in a predetermined direction;
a lens unit disposed along a light path of the light reflected from the mirror unit; and
a reading member to detect the light passing through the lens unit and to read the about the malfunctioning nozzle from the print medium,
wherein the light source, the reflection unit, the mirror unit, the lens unit, and the reading member are installed in the case.

8. The inkjet image forming apparatus of claim 7, wherein the mirror unit comprises a single mirror.

9. The inkjet image forming apparatus of claim 7, wherein the detecting unit radiates complementary color lights onto the first and second test print patterns to increase an efficiency of the detection of the malfunctioning nozzle.

10. A method of detecting a malfunctioning nozzle in an inkjet image forming apparatus which includes a printhead having nozzle unit and having a length corresponding to a width of a print medium or longer, the method comprising:
printing first test print patterns to detect a group of nozzles having a malfunctioning nozzle;
detecting the group of nozzles having the malfunctioning nozzle using the first test print patterns;
printing second test print patterns to detect a position of the malfunctioning nozzle in the group of nozzles having the malfunctioning nozzle; and
detecting the position of the malfunctioning nozzle using the second test print patterns.

11. The method of claim 10, wherein the printing of the first test print patterns comprises:
printing reference indicators to indicate locations of a plurality of groups of nozzles, including the group of nozzles having the malfunctioning nozzle, in the first test print patterns such that the detecting unit can detect the locations of the plurality of groups of nozzles.

12. The method of claim 11, wherein the reference indicators are lines having a predetermined length in a transferring direction of the print medium, and are spaced apart from each other in a width direction of the print medium.

13. The method of claim 10, wherein the printing of the second test print patterns comprises:
sequentially driving the nozzles of the group of nozzles having the malfunctioning nozzle at predetermined time intervals and starting from a first nozzle in order to print the second test print patterns such that the detecting unit can detect the position of the malfunctioning nozzle in the group of nozzles having the malfunctioning nozzle.

14. The method of claim 10, wherein the detecting unit comprises:
a light emitting unit to radiate light onto the print medium; and
a light receiving unit to receive light reflected from the print medium.

15. The method of claim 10, wherein the detecting unit comprises:
a reading unit to radiate light onto the print medium on which ink is ejected when passing through the nozzle unit, to detect light reflected from the print medium, and to read information about a malfunctioning nozzle from the print medium.

16. The method of claim 15, wherein the reading unit comprises:
a case;
a light source emitting light to emit light onto the print medium;
a reflection unit which is installed apart from the light source at a predetermined distance to reflect the light emitted from the light source toward the print medium;
a mirror unit to reflect the light reflected from the print medium in a predetermined path;
a lens unit disposed along a light path of the light reflected from the mirror unit; and
a reading member to detect the light passing through the lens unit and to read the information about the malfunctioning nozzle from the print medium,
wherein the light source, the reflection unit, the mirror unit, the lens unit, and the reading member are installed in the case.

17. The method of claim 15, wherein the detecting unit radiates complementary color lights onto the first and second test print patterns to increase an efficiency of the detection of the malfunctioning nozzle.

18. The method of claim 10, wherein the detecting of the group of nozzles having the malfunctioning nozzle comprises:
detecting the first test print patterns a number of times n, where n is an integer; and
counting a number of times z, where z is an integer, of the number of times n that a detected voltage is higher that a threshold voltage for a predetermined location on the print medium corresponding to a nozzle of the group of nozzles having the malfunctioning nozzle.

19. The method of claim 18, wherein an efficiency of the detection of the malfunctioning nozzle is enhanced by controlling the threshold voltage.

20. The method of claim 10 further comprising:
after detecting the position of the malfunctioning nozzle, performing a maintenance operation to keep the malfunctioning nozzle in a standby state.

21. An inkjet image forming apparatus, comprising;
a conveying unit to convey a print medium in a conveying direction;
a nozzle unit comprising a plurality of groups of nozzles to eject ink onto the print medium; and
a detecting unit downstream of the nozzle unit in the conveying direction to detect whether the nozzle unit has a defective nozzle using first electrical signals corresponding to a first printed pattern and a location of a group of nozzles including the defective nozzle when it is determined that the nozzle unit has a defective nozzle using the first electrical signals, and to detect a position of the defective nozzle in the group of nozzles including the defective nozzle using second electrical signals corresponding to a second printed pattern.

22. A method of detecting a position of a defective nozzle of a nozzle unit including a plurality of groups of nozzles of an inkjet image forming apparatus, the method comprising:
detecting a location of a group of nozzles of the plurality of groups of nozzles that includes the defective nozzle using a first print result; and
detecting the position of the defective nozzle in the group of nozzles that includes the defective nozzle unit using a second print result.

23. The method of claim 22, wherein the detecting of the location comprises:
determining whether the plurality of groups of nozzles has a the group of nozzles that include the defective nozzle using first electrical signals corresponding to the first print result; and
detecting the location of the group of nozzles that includes the defective nozzle when it is determined that the nozzle unit has the defective nozzle using the first electrical signals.

24. The method of claim 22, wherein the detecting of the position comprises:
detecting a position of the defective nozzle in the group of nozzles that includes the defective nozzle using second electrical signals corresponding to the second print result.

25. The method of claim 22, further comprising:
driving the plurality of groups of nozzles to generate the first print result, and driving only the group of nozzles having the defective nozzle to generate the second print result.

26. The method of claim 23, wherein the detecting the location of the group of nozzles that includes the defective nozzle comprises:
comparing intensities of the first electrical signals to a first predetermined threshold intensity; and
identifying an electric signal of the first electric signals that has an intensity above the predetermined threshold intensity.

27. The detecting unit of claim 23, wherein the detecting of the position of the defective nozzle comprises:
comparing intensities of the second electrical signals to a second predetermined threshold intensity; and
generating an information signal including the position of the defective nozzle in the group of nozzles that includes the defective nozzle using the comparison.
